(19) United States
(12) Patent Application Publication
(10) Pub. No.: US 2005/0197066 A1
(43) Pub. Date: Sep. 8, 2005

(54) Non-linear distortion compensation circuit for multi-carrier transmission

(75) Inventor: Hidenori Maruyama, Tokyo (JP)

Correspondence Address: Paul J. Esatto, Jr.;Scully, Scott, Murphy & Presser, 400 Garden City Plaza, Garden City, Garden City, NY, 11530, US

(73) Assignee: NEC Corporation, Tokyo (JP)

(21) Appl. No.: 11/067,810

(22) Filed: Feb. 28, 2005

(30) Foreign Application Priority Data
Mar. 3, 2004 (JP) 058322/2004

(51) Int. Cl. H04B 1/00

(52) U.S. Cl. 455/63.1; 330/149

(57) ABSTRACT

To provide a non-linear distortion compensation circuit for multi-carrier transmission in which the non-linear distortion and the consumption power can be reduced by a simple method. A frame format control section notifies the frame format information on transmission data to a transmission amplification control section, which selects the optimal amplifier from the power amplifiers of a variable transmission amplification section in accordance with the notified frame format information. In the variable transmission amplification section, the switch selects the low power amplifier having higher efficiency at the time of transmission on the channel requiring no power, in which the transmission level is finely adjusted by the attenuator for transmission. Also, the switch selects the high power amplifier by giving priority to the linearity over the efficiency at the time of transmission on the channel requiring high power, in which the transmission level is finely adjusted by the attenuator for transmission.

### BACKGROUND OF THE INVENTION

1. Field of the Invention

The present invention relates to a non-linear distortion compensation circuit for multi-carrier transmission, and more particularly to a non-linear distortion compensation circuit for multi-carrier transmission to compensate a non-linear distortion occurring with high output amplification of a multi-carrier transmitting signal.

2. Description of the Related Art

One example of multi-carrier transmission is an OFDM (Orthogonal Frequency Division Multiplex). This is a system called an orthogonal frequency division multiplex, which is utilized for the digital broadcasting or radio access. The features of this system are a high utilization efficiency of frequency and a high endurance of the modulation system itself to multi-path distortion, because of the multi-carrier transmission system employing the orthogonal frequency.

However, since the OFDM modulated wave has a high peak factor, the transmission quality is degraded due to non-linear distortion of a transmission amplifier, unless the back off of the transmission amplifier is sufficient. Also, a side lobe level of frequency spectrum is enhanced, resulting in a problem that the adjacent channel interference amount is increased.

On the other hand, from the viewpoint of power saving, the back off of the transmission amplifier is not taken too large. The back off and the non-linear distortion are in a reciprocal relationship, whereby it is necessary to set up the back off in the trade-off for the non-linear distortion.

A conventional technique for reducing the non-linear distortion of the transmission amplifier is a pre-distortion. This technique involves giving an inverse characteristic of non-linearity of the transmission amplifier to an input signal of the transmission amplifier, and removing the non-linear distortion from the output of the transmission amplifier as much as possible (e.g., refer to Japanese Patent Laid-Open Nos. 11-215197 and 2000-22659).

FIG. 5 shows a configuration of a conventional non-linear distortion compensation circuit. In FIG. 5, the conventional non-linear distortion compensation circuit for removing the non-linear distortion as much as possible includes an OFDM modulator 3, a pre-distortion circuit 4, a frequency conversion section 5, and a transmission amplifier 6.

The OFDM modulator 3 includes an S/P converter 31 for S/P (serial/parallel) converting the transmission data, a sub-carrier modulation circuit 32, an IFFT (Inverse Fast Fourier Transform) section 33, a G/I (Guard/Interval) addition section 34, and a waveform shaping section 35.

Also, the pre-distortion circuit 4 includes a level detector 41 for detecting the transmission power or amplitude of the OFDM modulated wave, an A/D (analog/digital) converter 42 for quantizing the power or amplitude information, a look-up table (LUT) 43 for looking up a complex compensation coefficient for pre-distortion with the output of the A/D converter 42 as the address, and a complex multiplier 44 for making the complex multiplication of an OFDM transmission signal with the looked up information.

The frequency converter 5 converts the complex multiplied signal by the complex multiplier 44 to a desired frequency. The transmission amplifier 6 converts the frequency-converted signal by the frequency converter 5 to a desired power.

The above technique is a pre-distortion method of calculating the power of a baseband signal from the orthogonal signals I, Q, looking up a complex compensation coefficient according to the transmission power from the table, and making the complex multiplication of the orthogonal signals I, Q for transmission. Another technique applying this pre-distortion method has been already offered (e.g., refer to Japanese Patent Laid-Open No. 2001-251274).

Also, in a WCDMA (Wideband-Code Division Multiple Access) transmission that is one example of a conventional transmission method, various kinds of information are transmitted by time division multiplexing of a control channel and a data channel, as shown in FIG. 4 (e.g., refer to “FIG. 10: Downlink slot format in case of multi-code transmission” [3GPP (3rd Generation Partnership Project) TS25.211 V3.12.0 (2002-09)]).

Moreover, another conventional transmission method involves varying the bias value of an amplifier in accordance with a changed modulation method or the input number of carriers to prevent degradation in the transmission quality (e.g. refer to Japanese Patent Laid-Open No. 2001-244828).

In the conventional multi-carrier transmission as described above, when the modulation method and the signal frame format are combined for transmission, it is required to have a large dynamic range for a diode detector as means detecting the amplitude or power of a transmission signal in applying the pre-distortion, resulting in a problem that an analog circuit causes a dispersion in characteristic.

Also, in the conventional pre-distortion system, an arithmetical operation circuit for specifying the amplitude or power of a transmission signal is required, increasing the circuit scale or consumption power even employing the digital processing.

Moreover, in the transmission system using the conventional signal frame format, when the transmission power is controlled independently for a pilot channel, a user data channel and the like, it is necessary to further expand the dynamic range for the transmission amplifier, resulting in a problem with the back-off measure or consumption power.

Moreover, with the technique as disclosed in Japanese Patent Laid-Open No. 2001-244828, there is a limit on the dynamic range for making the bias value variable in the multi-carrier transmission such as OFDM, because the bias value alone is varied.

### SUMMARY OF THE INVENTION

An object of the present invention to provide a non-linear distortion compensation circuit for multi-carrier transmission in which the non-linear distortion and the consumption power can be reduced by a simple method.

The present invention provides a non-linear distortion compensation circuit for multi-carrier transmission comprising means notifying frame format information on transmission data before multi-carrier modulation, amplification means amplifying and outputting the transmission data after multi-carrier modulation, and control means controlling the output level of the amplification means based on the notified frame format information.

In the non-linear distortion compensation circuit for multi-carrier transmission according to the present invention, the control means controls the output level of the amplification means based on the frame format information on the transmission data to reduce the non-linear distortion. Therefore, no conventional means for detecting the transmission signal level is required, whereby it is simply possible to reduce the non-linear distortion, expand the dynamic range and reduce the consumption power.

Thereby, in the non-linear distortion compensation circuit for multi-carrier transmission according to the present invention, when the multi-carrier transmission is performed, the amplitude information and the transmission power information included in the frame format information on the transmission data are notified to the control means, and the optimal transmission amplifier is selected to perform the transmission, whereby it is possible to reduce the non-linear distortion and the consumption power simply.

The present invention has the effect that the non-linear distortion and the consumption power are reduced by the simple method owing to the following configuration and operation.

### BRIEF DESCRIPTION OF THE DRAWINGS

FIG. 1 is a block diagram showing the configuration of a non-linear distortion compensation circuit for multi-carrier transmission according to an embodiment of the present invention;

FIG. 2 is a block diagram showing the configuration of a variable transmission amplification section of FIG. 1;

FIG. 3 is a diagram showing a control example of the non-linear distortion compensation circuit for multi-carrier transmission according to the embodiment of the present invention;

FIG. 4 is a diagram showing one example of the conventional transmission method; and

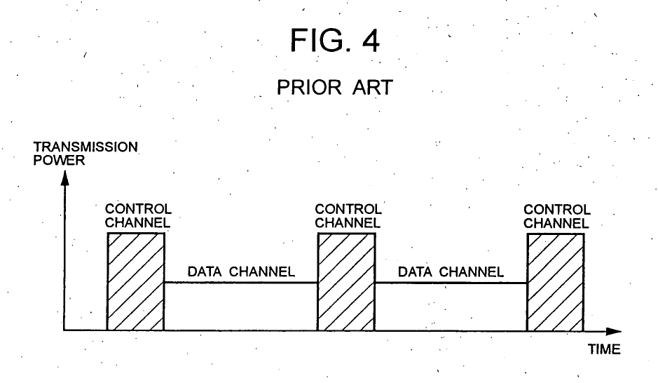

FIG. 5 is a block diagram showing the configuration of the conventional non-linear distortion compensation circuit.

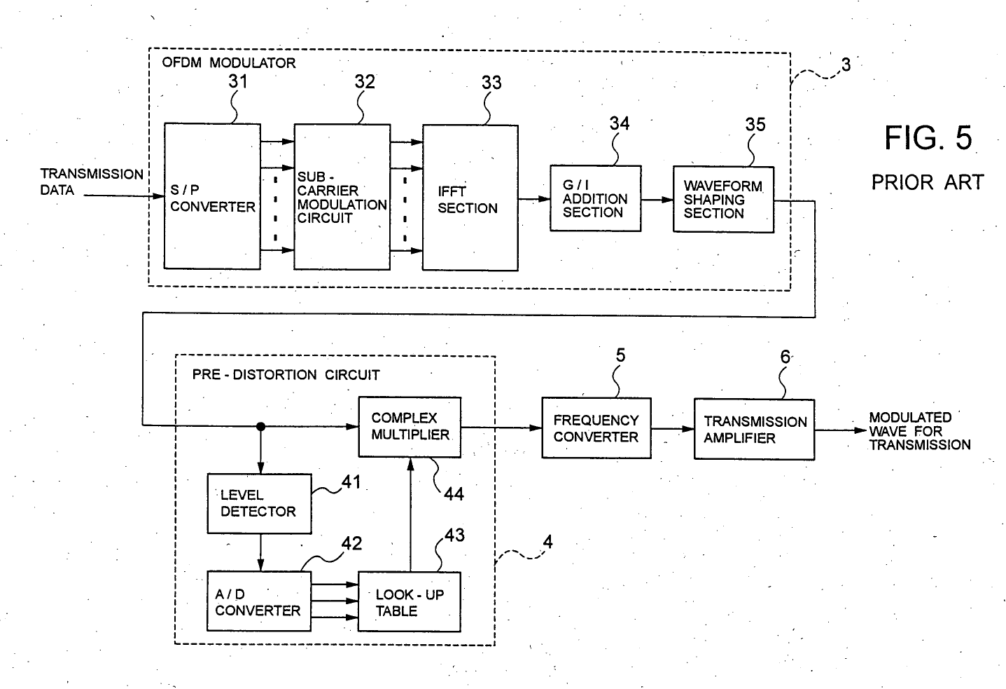

### DETAILED DESCRIPTION OF THE PREFERRED EMBODIMENTS

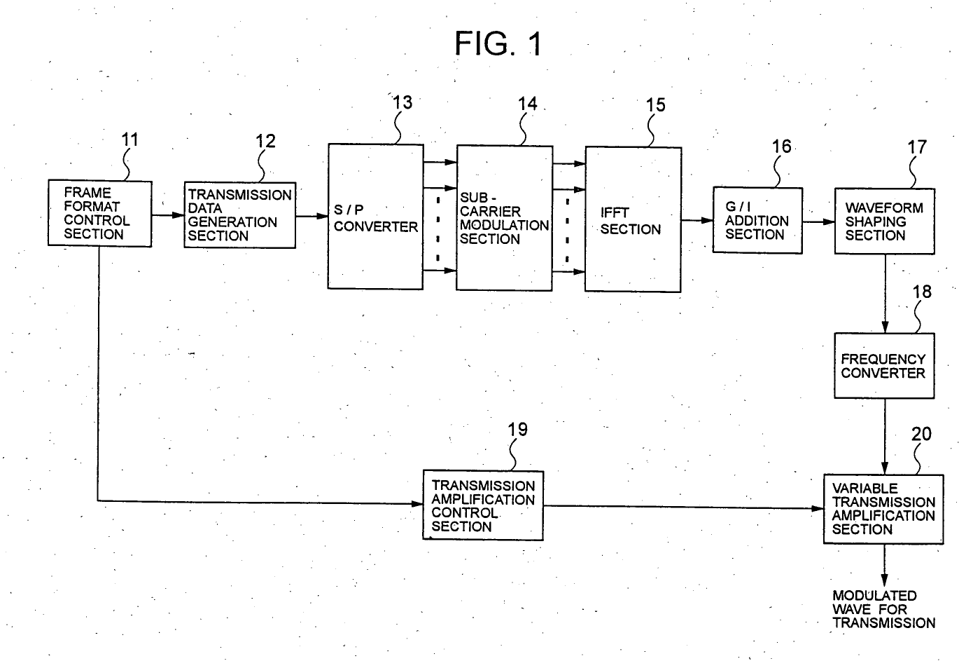

The preferred embodiment of the present invention will be described below with reference to the drawings. FIG. 1 is a block diagram showing the configuration of a non-linear distortion compensation circuit for multi-carrier transmission according to an embodiment of the present invention. In FIG. 1, the non-linear distortion compensation circuit for multi-carrier transmission according to the embodiment of the invention includes a frame format control section 11, a transmission data generation section 12, an S/P (serial/parallel) converter 13, a sub-carrier modulation section 14, an IFFT (Inverse Fast Fourier Transform) section 15, a G/I (Guard/Interval) addition section 16, a waveform shaping section 17, a frequency converter 18, a transmission amplification control section 19, and a variable transmission amplification section 20.

The frame format control section 11 generates and controls a frame format for transmission data. The transmission data generation section 12 sends out the transmission data in accordance with the frame format specified by the frame format control section 11. The S/P converter 13 converts the transmission data from serial to parallel form.

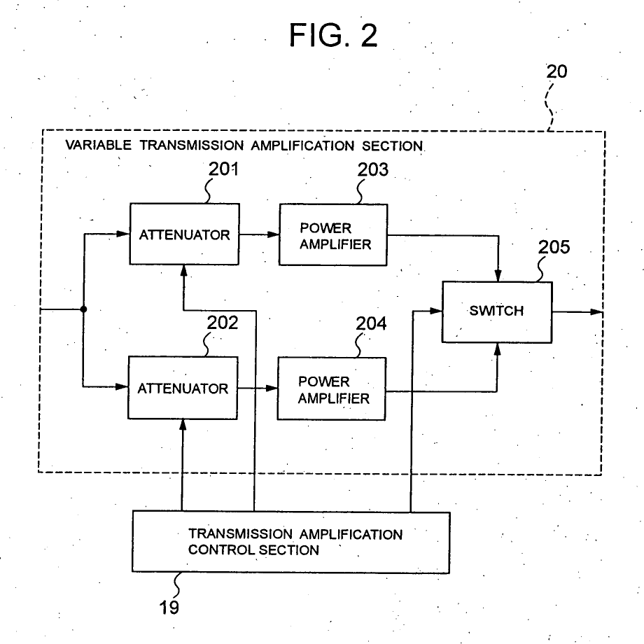

FIG. 2 is a block diagram showing the configuration of the variable transmission amplification section 20 of FIG. 1. In FIG. 2, the variable transmission amplification section 20 includes attenuators 201, 202, a low power amplifier 203, a high power amplifier 204, and a switch 205.

Referring to FIGS. 1 and 2, the operation of the non-linear distortion compensation circuit for multi-carrier transmission according to the embodiment of the invention will be described below. The transmission data is subjected to S/P conversion, sub-carrier modulation, IFFT, G/I addition, waveform shaping, and frequency conversion, and then inputted into the variable transmission amplification section 20 in the same manner as in the conventional example.

At this time, the frame format control section 11 notifies the frame format information to the transmission amplification control section 19, which controls the attenuators 201, 202, the low power amplifier 203, the high power amplifier 204, and the switch 205 for the variable transmission amplification section 20 based on the notified frame format information so that the transmission level may not be saturated at any time. The notified frame format information includes the amplitude information and transmission power information of each channel and the control timing information. The control timing information indicates switching timing between channels or a transmission time period of each channel.

In the variable transmission amplification section 20, the switch 205 selects the low power amplifier 203 having higher efficiency at the time of transmission on the channel requiring no power, in which the transmission level is finely adjusted by the attenuator 201 for transmission.

In the variable transmission amplification section 20, the switch 205 selects the high power amplifier 204 by giving priority to the linearity over the efficiency at the time of transmission on the channel requiring high power, in which the transmission level is finely adjusted by the attenuator 202 for transmission.

Though the variable transmission amplification section 20 in this embodiment has the above configuration, namely, comprises the attenuators 201, 202, the low power amplifier 203, the high power amplifier 204 and the switch 205, it may comprise any combination of those components at multiple stages or in series for more precise control.

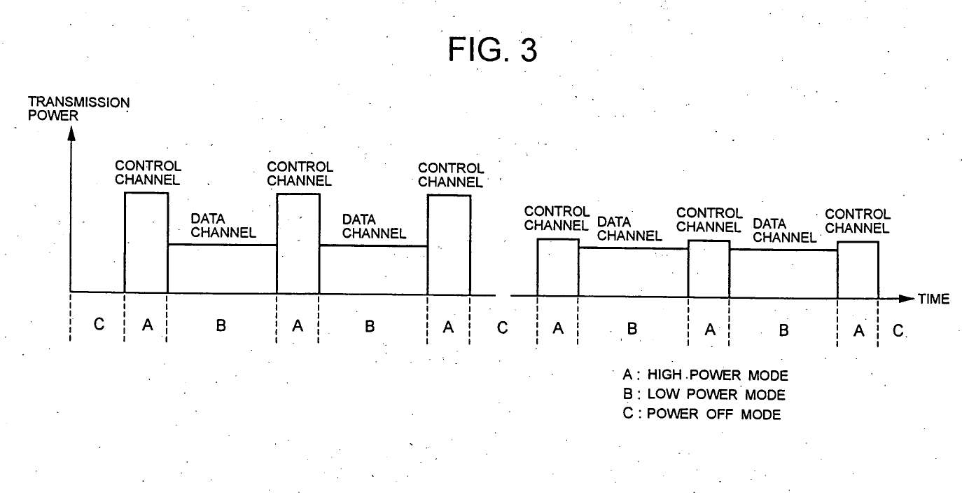

FIG. 3 is a diagram showing a control example of the non-linear distortion compensation circuit for multi-carrier transmission according to the embodiment of the invention. Referring to FIGS. 1 to 3, the control example of the non-linear distortion compensation circuit for multi-carrier transmission according to the embodiment of the invention will be described below.

In FIG. 3, there are cases where a control channel has high power, a data channel has low power, and both the control channel and the data channel have low power. In accordance with the frame format specified by the frame format control section 11, power off (see C in FIG. 3) is selected (the power supply to the power amplifiers 203 and 204 is cut) when there is no signal, high power amplification (see A in FIG. 3) is selected when high power is required for the pilot channel (control channel), and low power amplification (see B in FIG. 3) is selected when low power is required for the user data channel (data channel).

Also, in this embodiment, the power amplifiers 203 and 204 are turned off in a state where no data is transmitted in the packet transmission. Moreover, in this embodiment, the transmission amplification control section 19 operates in accordance with the control timing information and a delay time for which the transmission data reaches the variable transmission amplification section 20.

Thus, in this embodiment, the optimal transmission amplifier can be selected in accordance with the frame format of a transmission signal to reduce the non-linear distortion. This embodiment does not require the level detector or amplitude calculation circuit as means for acquiring the amplitude information of transmission signal in the conventional pre-distortion system, whereby the size, power and cost are reduced. Also, there is the effect that the dynamic range is expanded in this embodiment.

1. A non-linear distortion compensation circuit for multi-carrier transmission comprising:
means notifying frame format information on transmission data before multi-carrier modulation;
amplification means amplifying and outputting the transmission data after multi-carrier modulation; and
control means controlling the output level of the amplification means based on the notified frame format information.

2. The non-linear distortion compensation circuit for multi-carrier transmission according to claim 1, wherein the notified frame format information includes the amplitude information and the transmission power information for each channel.

3. The non-linear distortion compensation circuit for multi-carrier transmission according to claim 1, wherein the control means controls the output level of the amplification means based on the notified frame format information and a delay time for which the transmission data reaches the amplification means.

4. The non-linear distortion compensation circuit for multi-carrier transmission according to claim 1, wherein the amplification means has a plurality of power amplifiers, and the control means controls the output level of the amplification means by selecting any one of the plurality of power amplifiers based on the notified frame format information.

5. The non-linear distortion compensation circuit for multi-carrier transmission according to claim 4, wherein the plurality of power amplifiers comprise a low power amplifier and a high power amplifier.

6. The non-linear distortion compensation circuit for multi-carrier transmission according to claim 5, wherein the control means selects the high power amplifier when high power is required, and selects the low power amplifier when low power is required.

7. The non-linear distortion compensation circuit for multi-carrier transmission according to claim 4, wherein the power supply to the plurality of power amplifiers is cut when there is no signal.
